(19) United States
(12) Patent Application Publication
(10) Pub. No.: US 2003/0198014 A1
(43) Pub. Date: Oct. 23, 2003

(54) Electronic apparatus carrying unit having desired function selected from group including a plurality of units

(75) Inventor: Tomomi Murayama, Nishitama-gun (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/364,414

(22) Filed: Feb. 12, 2003

(30) Foreign Application Priority Data
Apr. 22, 2002 (JP) 2002-119546

(51) Int. Cl. G06F 1/16

(52) U.S. Cl. 361/685; 361/684

(57) ABSTRACT

An electronic apparatus includes a case which has a unit housing portion therein, a printed-circuit board which is built into the case in a portion other than the unit housing portion, and at least one unit which is selected from a group including a plurality of units having different occupied areas when arranged in a plane and stored in the unit housing portion.

### CROSS-REFERENCE TO RELATED APPLICATIONS

This application is based upon and claims the benefit of priority from the prior Japanese Patent Application No. 2002-119546, filed Apr. 22, 2002, the entire contents of which are incorporated herein by reference.

### BACKGROUND OF THE INVENTION

1. Field of the Invention

The present invention relates to electronic apparatus which is carrying in its internal unit housing portion with a selected unit having a desired function.

2. Description of the Related Art

A personal computer (hereinafter abbreviated as PC) generally has a hard disk drive (hereinafter abbreviated as HDD) as a memory device. A notebook size mobile PC is equipped with an HDD having a disk size of 2.5 inches on a standard basis. This HDD is relatively small-sized and suited for use as built-in a mobile PC.

A mobile PC has been utilized in a variety of fields and is desired to be compact and multi-functional. A user, on the other hand, does not require so many functions of a mobile PC and may tend to buy such a PC as to be well balanced between functions and a price thereof. Thus, specifications required by the users have been diversified. It is required that the mobile PC can carry selected units, which are united to every function and which satisfies specifications of each user, into a unit housing in the casing.

However, it is necessary to change mounting positions for every unit, parts for fixing each unit, and connecting portions between the printed-wiring board and each of the units, in order to install units, which have various functions with each, in to the same-size housing and satisfy the respective specifications.

Especially when a plurality of units having different functions is mounted together, it is necessary to prepare each combination of the attaching position that corresponds to conditions of each unit for installing. Furthermore, when the unit mounting positions are changed, it is necessary to change the shape of parts for fixing the units and a position where a connector is provided to interconnect each unit with the printed-wiring board. In such a case where a unit having a required function is selected and installed in such a manner, costs become high. Hence, it is hard to supply a PC having a reasonable price for users.

### BRIEF SUMMARY OF THE INVENTION

The present invention provides electronic apparatus which can carry a unit having a required function into the same-size case thereof smoothly and economically, and satisfy a various specifications.

An electronic apparatus of one embodiment according to the present invention has a case having a unit housing portion therein, a printed-circuit board which is built into the case of a portion other than the unit housing portion; and at least one unit which is selected from a group including a plurality of units having different occupied areas when arranged in a plane and is installed in the unit housing portion.

According to this configuration of the embodiment, it is possible to install each unit having a required function smoothly and economically into a case having the same outer profile.

Additional features and advantages of the embodiment will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view for showing an external view of a PC in one embodiment according to the present invention;

FIG. 2 is a plan view for showing an inside of a case in a condition where an upper case and a keyboard of the PC shown in FIG. 1 are detached and a printed-wiring board of an sound unit is arranged in a shifted position;

FIG. 3 is a plan view for showing a condition where a holding member is detached from the case shown in FIG. 2;

FIG. 4 is an illustration for showing a cross-sectional view of a lower case with units in a condition where the upper case and the keyboard of the PC shown in FIG. 1 are detached;

FIG. 5 is a perspective view for showing an external view of a PC install with a unit different from that of the PC shown in FIG. 1;

FIG. 6 is a plan view for showing an inside of a case in a condition where an upper case and a keyboard of the PC shown in FIG. 5 are detached;

FIG. 7 is an illustration for showing a cross-sectional view of a lower case with units in the condition shown in FIG. 6;

FIG. 8 is a plan view for showing an HDD having a disk size of 1.8 inches shown in FIG. 3;

FIG. 9 is a plan view for showing holding member and a battery shown in FIG. 2;

FIG. 10 is a plan view for showing an HDD having a disk size of 2.5 inches, its holding member, and a connection cable shown in FIG. 6;

FIG. 11 is a plan view for showing a wireless-LAN printed-wiring board and an auxiliary board shown in FIG. 2 in a condition where they are arranged in parallel with each other;

FIG. 12 is a layout diagram for schematically showing a condition where an HDD having a disk size of 1.8 inches and a wireless-LAN printed-wiring board are housed in a unit housing portion in the PC shown in FIG. 1; and

FIG. 13 is a layout diagram for schematically showing a condition where an HDD having a disk size of 2.5 inches is housed in a unit housing portion in the PC shown in FIG. 5.

### DETAILED DESCRIPTION OF THE INVENTION

The following will describe electronic apparatus of one embodiment related to the present invention in one example of a mobile personal computer (hereinafter abbreviated as PC) 100 with reference to drawings.

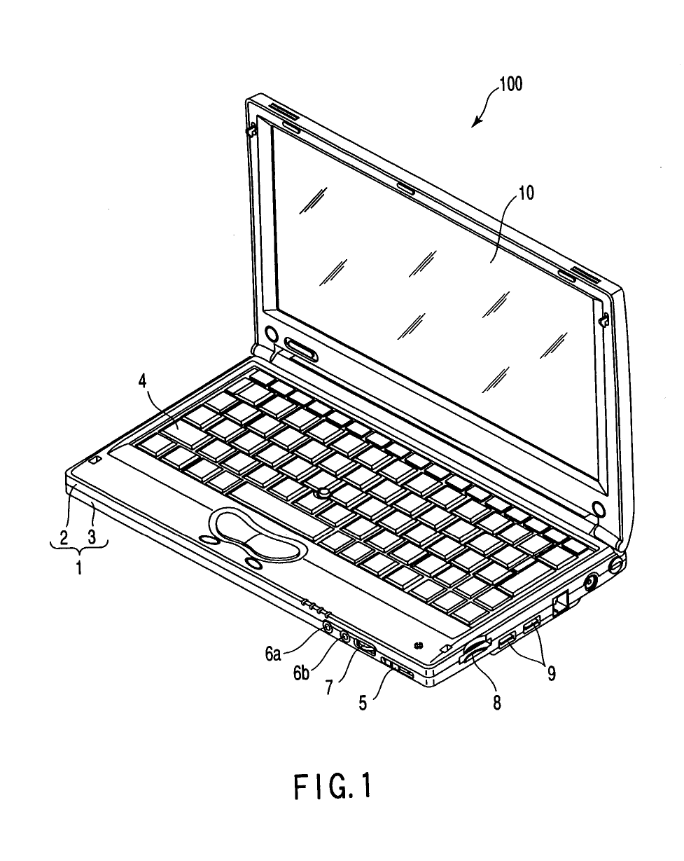

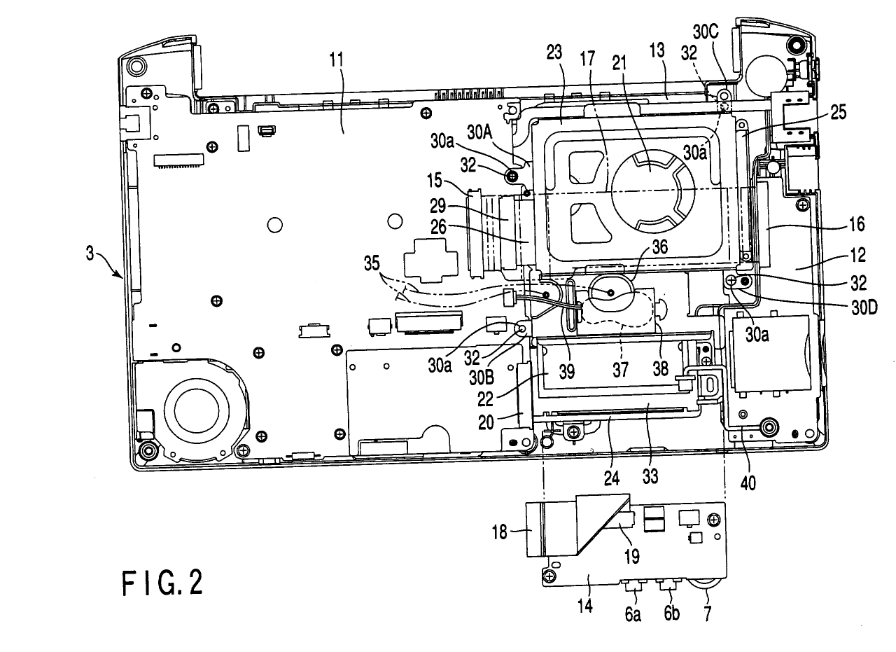

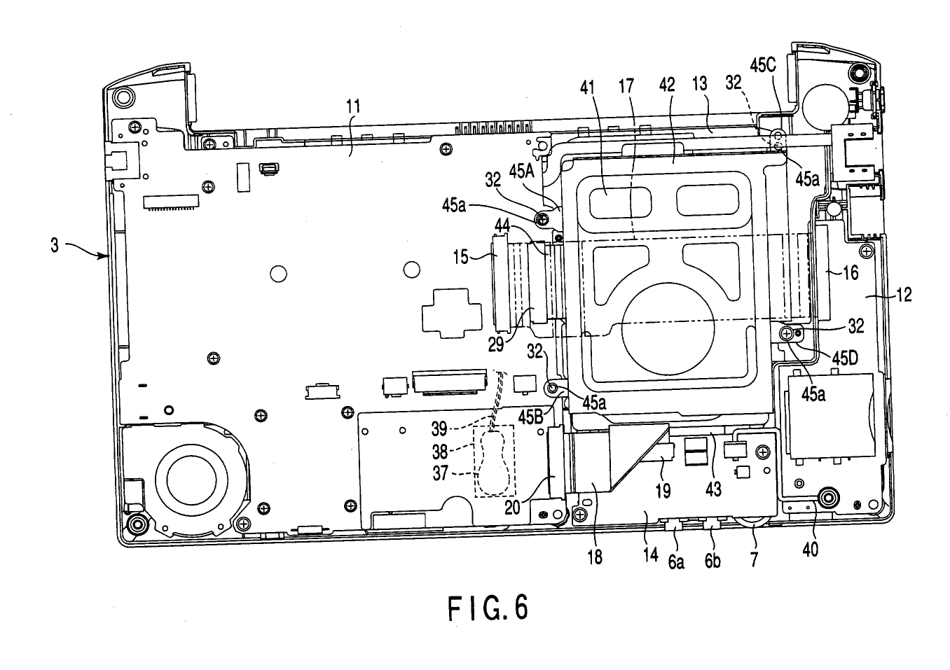

The PC100 shown in FIGS. 1 and 5 is provided with a unit housing portion 13 inside a case 1 as shown in FIGS. 2 and 6. Inside the case 1 are there incorporated a printed-wiring board 11 for a system and a printed-wiring board 12 for a connector as printed-circuit boards, in a portion other than the unit housing portion 13. In other words, in the PC100, the unit housing portion 13 is arranged between the printed-wiring boards 11 and 12.

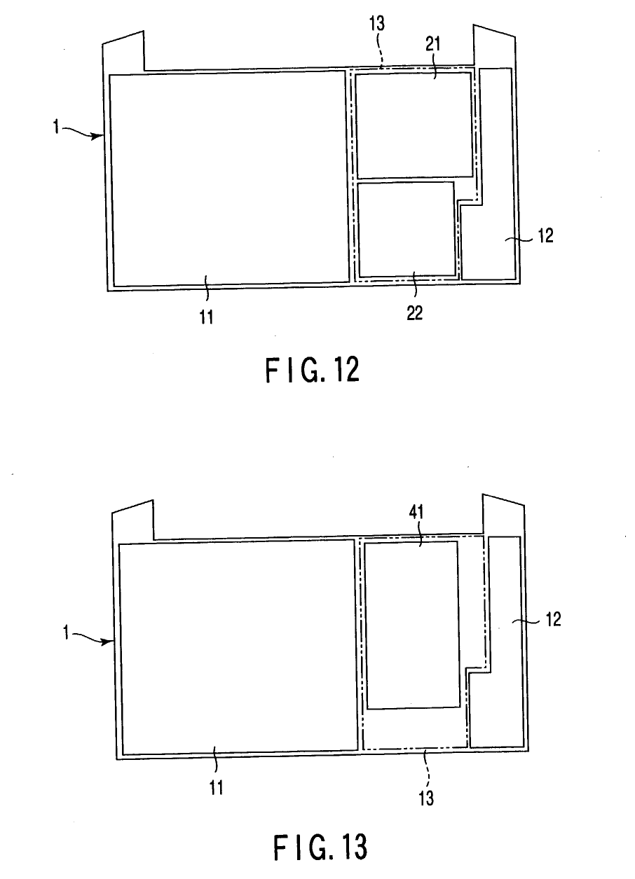

The unit housing portion 13 has at least two configurations: in one configuration, as shown in FIG. 2, are there stored as units a hard disk drive having a disk size of 1.8 inches (hereinafter abbreviated as 1.8″ HDD) 21 a printed-wiring board 22 for a wireless LAN, and a sound board 14 and in the other configuration, as shown in FIG. 6, are there stored as units a hard disk drive having a disk size of 2.5 inches (hereinafter abbreviated as 2.5″ HDD) 41 and a sound board 14. The PC100 in a condition of FIG. 2 is schematically shown in FIG. 12. The PC100 in a condition of FIG. 6 is schematically shown in FIG. 13.

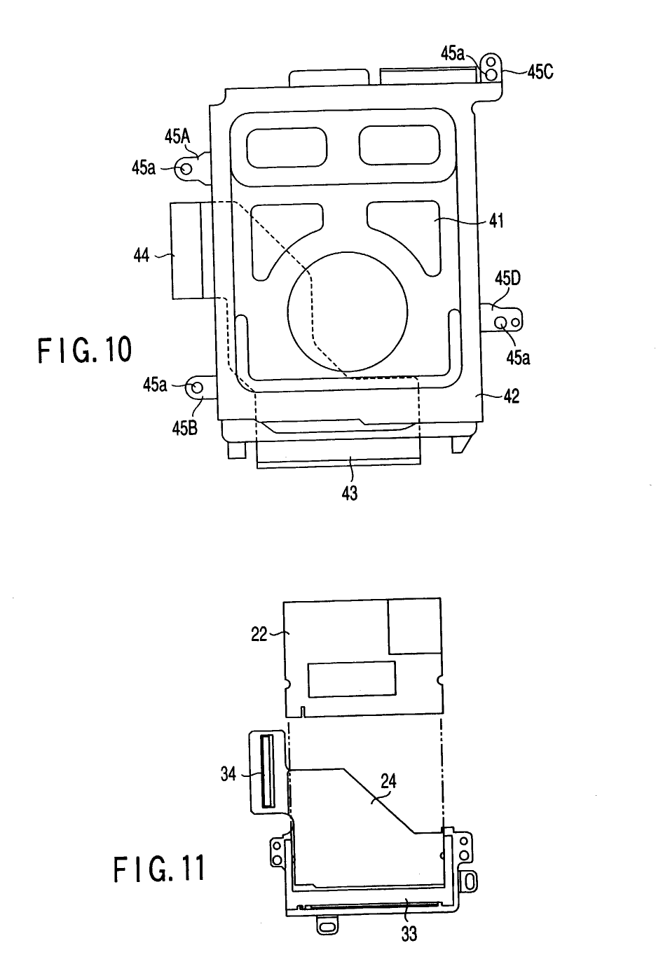

Thus, the unit housing portion 13 stores therein at least one unit which is selected from a group including a plurality of units having different occupied areas when arranged in a plane. Furthermore, in either case of the configuration, a memory device unit is always selected first. A unit, which can be stored in a remaining space other than that where the memory device unit is stored in the unit housing portion 13, is selected as the second unit and the subsequent. In this case, the units included in the group comprise the 2.5″ HDD 41 shown in FIG. 10, the 1.8″ HDD 21 shown in FIG. 8, the printed-wiring board 22 for the wireless-LAN shown in FIG. 11, and the sound board 14 shown in FIG. 2. The 2.5″ HDD 41 and the 1.8″ HDD 21 are one example of the memory device unit. The g1.8″ HDD 21 is a small-sized memory device unit smaller than the 2.5″ HDD 41 in terms of occupied area when arranged in a plane. The 1.8″ HDD 21 and the 2.5″ HDD 41 have basically the same functions. The 1.8″ HDD 21 is smaller than the 2.5″ HDD 41 because the former has a smaller size of a built-in disk than the latter. The 1.8″ HDD 21 either has the same storage capacity as the 2.5″ HDD 41 or has a smaller storage capacity than it. That is, the 1.8″ HDD21 or 2.5″ HDD 41 is selectively installed in the unit housing portion 13 of the case 1 as units having the same functions and having different occupied areas when arranged in a plane. The printed-wiring board 22 is one example of a communication unit. The sound board 14 is one example of an sound unit.

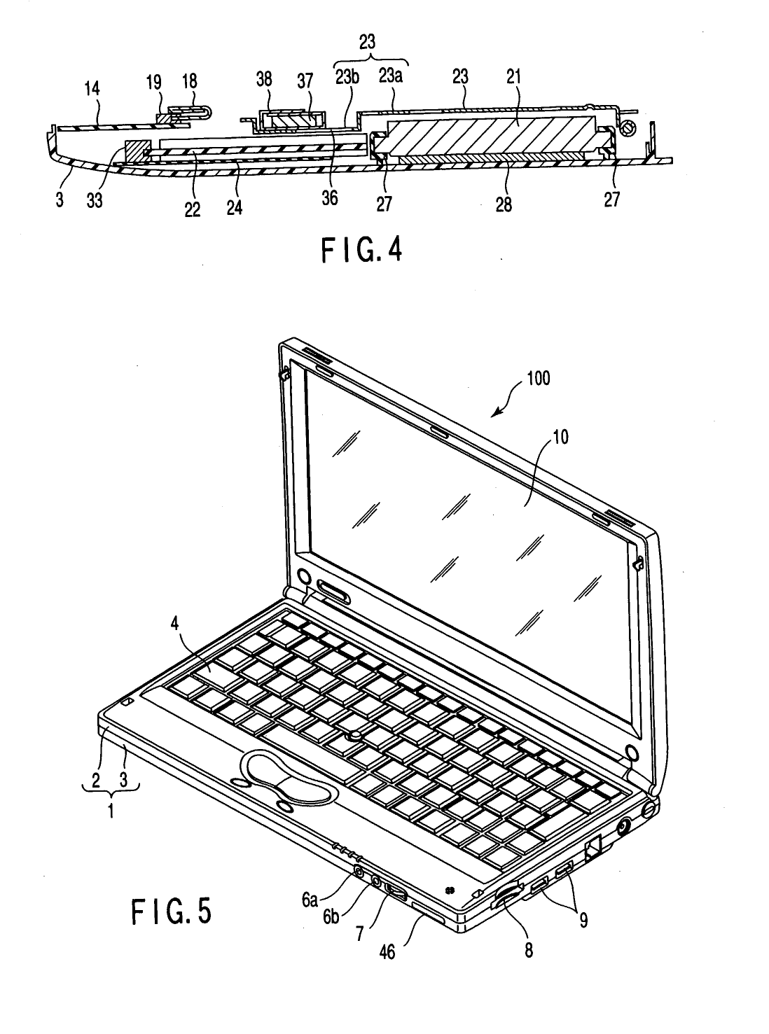

First, the PC100 in which the 1.8″ HDD 21 is assembled is described with reference to FIGS. 1-4, 8, 9, 11, and 12.

The PC100 shown in FIG. 1 is provided with the case 1. The case 1 is formed as a thin and flat rectangular parallelepiped by combining an upper case 2 and a lower case 3. A keyboard 4, which has a number of keys are arranged for inputting operations, is attached on the top of the case 1. A switch 5 of, for example, a sliding type for turning ON/OFF a circuit of the printed-wiring board 22 for a wireless LAN described later, a microphone terminal 6a and a headphone terminal 6b which are mounted on the sound board 14, and a sound-volume adjustment dial 7 are exposed on a front edge portion of the case 1. Connecting terminals such as a card slot 8 and a USB terminal 9 are provided on a side edge of the case 1. A display unit 10 is supported at right and left ends on a rear edge portion of the case 1, and can swing in a direction to leave away from the case 1.

As shown in FIG. 2, the 1.8″ HDD 21 is fixed with a holding member 23 at a position which is rather near a rear part of the unit housing portion 13. Furthermore, the printed-wiring board 22 for the wireless-LAN is mounted on an auxiliary board 24 arranged rather near a front part of the unit housing portion 13. It is to be noted that in FIG. 2 the sound board 14 is shown as shifted from its due position so that the printed-wiring board 22 can be seen.

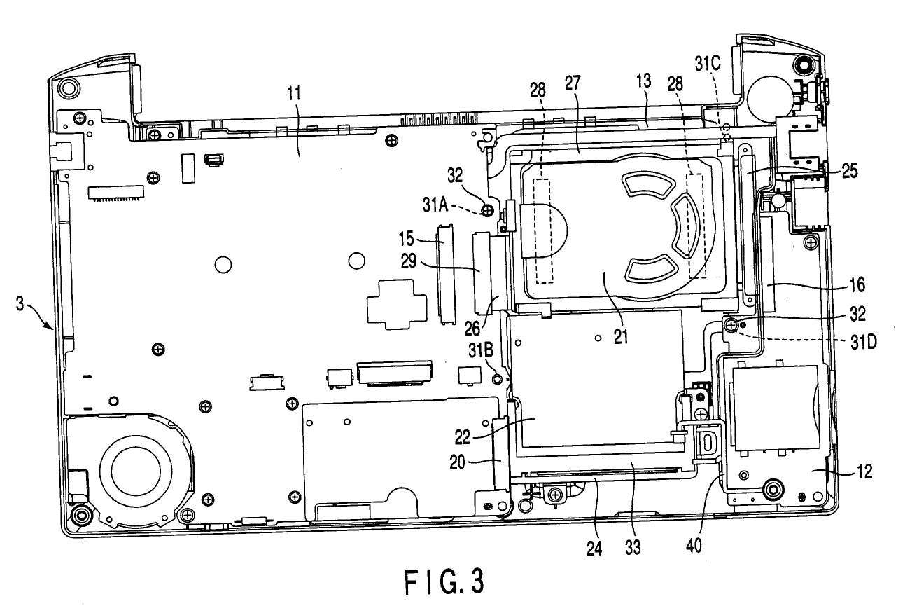

As shown in FIGS. 3 and 12, the 1.8″ HDD 21 has roughly half a size of the unit housing portion 13 in the direction from the front and the rear of the case 1. The 1.8″ HDD has in its rectangular parallelepiped casing a hard disk having a disk size of 1.8 inches and its driving mechanism. The 1.8″ HDD 21 has a connector 25 at its right end in FIGS. 2 and 8.

As shown in FIG. 8, a flexible cable 26 connected to the connector 25 is arranged in such a manner as to go along the bottom face of the 1.8″ HDD 21 and project to the outside from a left end of the 1.8″ HDD 21. The 1.8″ HDD 21 has an elastic frame 27 made of, for example, rubber as an elastic member as fitted to all the circumference of an outer edge of the casing for the purpose of prevention of vibration. In the unit housing portion 13, a plurality of insulators 28 are attached in parallel with each other between inner face of the lower case 3 at a rear portion and the 1.8″ HDD 21. The 1.8″ HDD 21 is arranged as mounted on the plurality of insulators 28. In this condition, the elastic frame 27 of the 1.8″ HDD 21 butts against the inner face of the lower case 3. Therefore, the 1.8″ HDD 21 is supported on the inner face of the lower case 3 by the elastic frame 27 and the insulator 28.

As shown in FIGS. 2 and 3, the flexible cable 26 connected to the 1.8″ HDD 21 is detachably connected to a common connector 29 provided on the printed-wiring board 11. The common connector 29 is arranged in the direction from the front to the rear of the case 1 on the upper face of the printed-wiring board 11 near the unit housing portion 13, and is connected to a circuit on the printed-wiring board 11.

As shown in FIG. 9, the holding member 23 is separate from the 1.8″ HDD 21 and, in fact, is superposed thereon from the above and attached on the inner face of the lower case 3. The holding member 23 is made of a plate material such as metal. The holding member 23 is comprised of an HDD cover 23a and an extension 23b.

The HDD cover 23a is formed a size larger than the outer profile of the 1.8″ HDD 21. The HDD cover 23a fits the outer profile of the 1.8″ HDD 21 to thereby rigidly fix it and also relax impact due to input operations received from the keyboard 4. The extension 23b partially covers the printed-wiring board 22 arranged in parallel with the 1.8″ HDD 21.

The holding member 23 is formed assembling pieces 30A, 30B, 30C, and 30D extending from the outer edge to the outward. Each of the mounting piece 30A-30D are opened a hole 30a through which a screw passes.

Furthermore, as shown in FIG. 3, screw holes 31A, 31B, 31C, and 31D which correspond to the holes 30a of the assembling pieces 30A, 30B, 30C, and 30D of the holding member 23 respectively are formed a round the unit housing portion 13. In the present embodiment, the screw holes 31A and 31B are provided in such a manner as to go through the edge of the printed-wiring board 11. The screw hole 31C is provided in the unit housing portion 13 at the rear end of the lower case 3. The screw hole 31D is provided in such a manner as to go through the edge of the printed-wiring board 12. In this configuration, by tightening a screw 32 into the screw holes 31A-31D through the hole 30a in the assembling pieces 30A-30D respectively, the holding member 23 is fixed to the unit housing portion 13. In such a manner, the 1.8″ HDD 21 is pressed downward by the HDD cover 23a, and is fixed into the unit housing portion 13.

In this case, the elastic frame 27 and the insulator 28 can relax external impact and vibration exerted on the 1.8″ HDD 21. Furthermore, the screw holes 31A-31D are used commonly also in a case where units having different sizes are mounted. The extension 23b is not only extended to fix the holding member 23 through the common screw holes 31A-31D but also enhanced strength of the holding member 23 by being bended.

As shown in FIG. 11, the printed-wiring board 22 for the wireless-LAN is arranged on the unit housing portion 13 between the holding member 23 and the lower-part case 3. The printed-wiring board 22 has a function to conduct wireless LAN communication. The printed-wiring board (wireless-LAN unit) 22 is formed a printed wiring for constituting a circuit on its board made of an insulating material and is mounted electronic components. The printed-wiring board 22 is provided at its one edge with a number of terminals (not shown) arranged in parallel with each other and in an edge direction.

In FIG. 3, the printed-wiring board 22 has rectangular shape and a size corresponding to the width of the unit housing portion 13 in a direction of from the right to the left of the case 1. The printed-wiring board 22 is mounted on the auxiliary board 24 arranged in parallel with the lower case 3, at a position below and in front of the unit housing portion 13.

The auxiliary board 24 has a size enough to be mounted with the printed-wiring board 22 thereon. The auxiliary board 24 has a connector 33, which is detachably connected with the terminal of the printed-wiring board 22, on the upper face and a connector 34 at its edge which faces the side of the printed-wiring board 11. The auxiliary board 24 has a printed wiring (not shown) formed thereon which interconnects the connectors 33 and 34. The auxiliary board 24 is arranged inside the lower case 3 rather the lower section and detachably connected to a connector (not shown) which is provided on the bottom face of the printed-wiring board 11 by the connector 34.

As shown in FIG. 2, the printed-wiring board 22 is provided with an antenna wire 35. The antenna wire 35 is passed through a hole 36 formed in the extension 23b and drawn out from below to the above of the extension 23b . The antenna wire 35 is wired to the rear of the case 1. Furthermore, the antenna 35 is wired also to the inside of the display unit 10 in order to improve the condition of wireless communication. The antenna wire 35 is passed through the hole 36, thus being wired without being blocked by the extension 23b.

Since the printed-wiring board 22 and the auxiliary board 24 are interconnected by the connector 33, and the auxiliary board 24 and the printed-wiring board 11 are interconnected by the connector 34, it is easy to assemble into the unit housing portion 13 the printed-wiring board 22 selected as a unit.

The printed-wiring board 22 is thin as compared to the 1.8″ HDD 21, so that a space is left unused above the printed-wiring board 22 in the unit housing portion 13. Therefore, a step is formed from the HDD cover 23a downward to the extension 23b as much as the height of the space so that the extension 23b may go along the upper face of the printed-wiring board 22. A battery 37 is arranged in the space provided above the extension 23b . The battery 37 is used to supply power to a timer circuit included in the system printed-wiring board 11, which is a mother board. The battery 37 is covered by an insulating protection sheet 38 and protected against external force. The protection sheet 38 is adhered onto the extension 23b. A cord 39 extending from the battery 37 is connected at a suitable position on the printed-wiring board 11. The extension 23b can be utilized also to hold the battery 34, so that a space provided above the printed-wiring board 22 can be utilized effectively.

The printed-wiring board 11 has a function to, for example, control system operations of the PC100 as a whole and process input information and output it. The printed-wiring board 11 is formed a printed wiring on its board made of an insulating material, and is mounted electronic components. In the present embodiment, the printed-wiring board 11 occupies almost a left half region of the internal space of the case 1 and is arranged in parallel with the upper face of the case 1.

The printed-wiring board 12 has a function to process information received through the card slot 8 or a connection terminal such as the USB terminal 9 and information to be output. The printed-wiring board 12 is formed a printed wiring on its board made of an insulating material and is mounted electronic components thereon. The printed-wiring board 12 is formed as elongated in a direction from the front to the rear of the case 1 and arranged in parallel with the upper face of the case 1 rather near the right end inside the case 1.

A connector 15 connected to a circuit of the printed-wiring board 11 is provided at such a position on the upper face of the printed-wiring board 11 as to be near the unit housing portion 13 along a direction from the front to the rear of the case 1, and a connector 16 connected to a circuit of the printed-wiring board 12 is provided at such a position on the upper face of the printed-wiring board 12 as to be near the unit housing portion 13 along a direction from the front to the rear of the case 1. A flexible cable 17 goes beyond the unit housing portion 13, to be connected to the connectors 15 and 16 detachably. As a result, the printed-wiring board 11 and the printed-wiring board 12 are interconnected, to transfer information therebetween. Since the flexible cable 17 is used, the printed-wiring boards 11 and 12 are interconnected without being blocked by a unit stored in the unit housing portion 13.

The sound board 14 has a function to process an audio signal received through a microphone terminal 6a and an audio signal to be output through the headphone terminal 6b. Similar to the printed-wiring boards 11 and 12, the sound board 14 is formed a printed wiring on its board made of an insulating material in order to make up a circuit thereon and is mounted electronic components thereon. The sound board 14 is a small rectangle in shape having a length that can be accommodated by the width of the unit housing portion 13 in a lateral direction of the case and arranged in parallel with the upper face of the case 1 at the front upper area in the unit housing portion 13 and fixed by a screw as shown in FIG. 6, for example. The sound board 14 is shown in FIG. 2 in a condition where it is detached from the lower case 3 and is shown in FIG. 6 in a condition where it is attached to the lower case 3. A connector 19 to which a flexible cable 18 is connected is attached onto the upper face on the sound board 14. The flexible cable 18 is detachably connected to a connector 20, which is attached on the upper face of the printed-wiring board 11 and connected to the circuit of the printed-wiring board 11. In such a manner, the printed-wiring board 11 and the sound board 14 are interconnected. Furthermore, the sound board 14 and the printed-wiring board 12 are interconnected via a cable 40. The sound board 14 is assembled into the unit housing portion 13 and then connected to the printed-wiring boards 11 and 12.

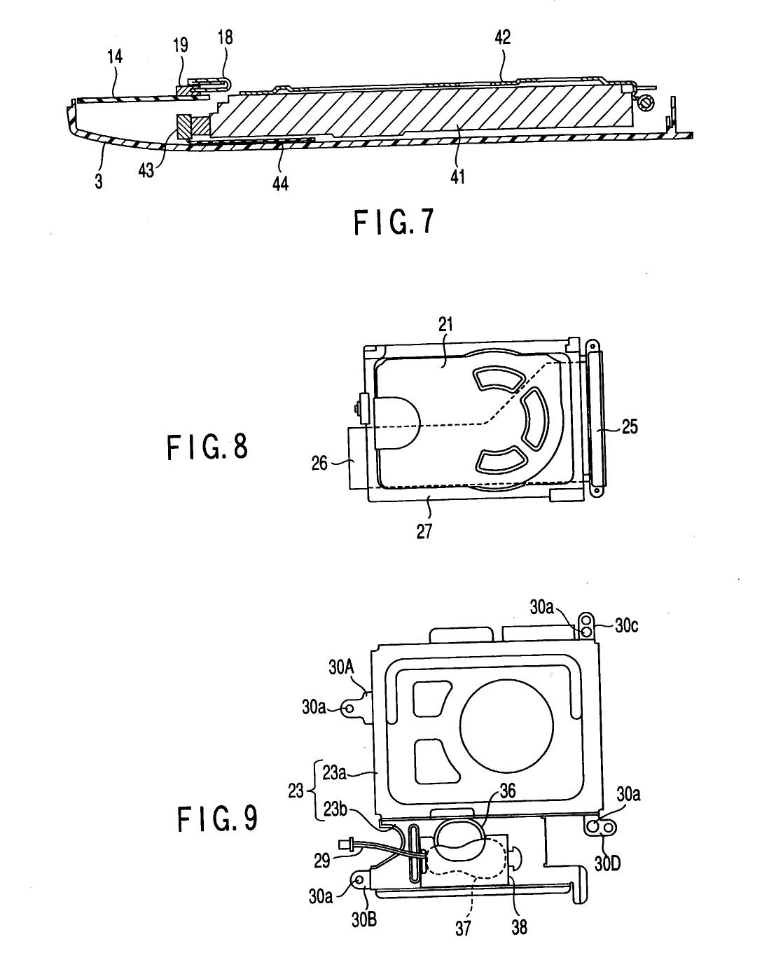

Next, the PC100, in which the 2.5″ HDD 41 is selected from the group of units and is installed, is described with reference to FIGS. 5-7, 10, and 13. It is to be noted that description is omitted of the same configuration of the PC100 as that in a case where the 1.8″ HDD 21 is installed.

The PC100 shown in FIG. 5 is not provided with the wireless-LAN printed-wiring board 22. As shown in FIG. 5, therefore, in the PC100, a blind patch 46 closes a hole provided so as to expose the switch 5 for turning ON/OFF the circuit of the printed-wiring board 22. As shown in FIG. 6, the PC100 has the 2.5″ HDD 41 built into the unit housing portion 13 of the case 1.

As shown in FIG. 10, the 2.5″ HDD 41 is equipped with a holding member 42. The 2.5″ HDD 41 is formed as a rectangular parallelepiped having roughly ⅔ a size of the unit housing portion 13 in a direction from the front to the rear of the case 1. The 2.5″ HDD houses a hard disk and its driving mechanism in its casing. The HDD 41 has a connector 43 at its front edge. A flexible cable 44 connected to the connector 43 is arranged along the bottom face of the 2.5″ HDD 41 and project to the outside from a side edge of the 2.5″ HDD 21 facing to the printed-wiring board 11.

The holding member 42 is formed so as to be of roughly the same size over the outer face of the 2.5″ HDD 41. The holding member 42 is lapped over the 2.5″ HDD 41 from the above. In FIG. 10, the right and left sides of the holding member 42 are folded so as to butt against the 2.5″ HDD 41 and be fixed thereto detachably using a screw not shown.

Furthermore, in FIG. 10, the holding member 42 has two mounting pieces 45A and 45B at the left edge, one mounting piece 45C at the right upper corner, and one mounting piece 45D at the right edge all of which project to the outward. Each of these mounting pieces 45A-4D is opened a hole 45a. Relative positional relationships (position and spacing dimensions) between these mounting pieces 45A-45D as well as the hole 45a and the respective mounting pieces 30A-30D of the holding member 23 for the 1.8″ HDD 21 are the same in the unit housing portion 13.

As shown in FIG. 6, the 2.5″ HDD 41 is arranged in the unit housing portion 13 in a condition where the connector 43 faces the front of the case 1. The flexible cable 44 is detachably connected to the common connector 29 provided on the printed-wiring board 11. The common connector 29 is capable of connecting thereto both the flexible cable 26 connected to the 1.8″ HDD 21 and the flexible cable 44 connected to the 2.5″ HDD 41. That is, the flexible cables 26 and 44 and the common connector 29 are manufactured in accordance with the same specifications. Accordingly, regardless of whether the 1.8″ HDD 21 or the 2.5″ HDD 41 is selected, because the connecting components are common to their respective cables, thus a configuration of the components are simplified and assemblies are facilitated.

The hole 45a in the mounting pieces 45A and 45B is provided at a position that corresponds to the respective screw holes 31A and 31B (shown in FIG. 3) formed through the printed-wiring board 11. The hole 45a in the mounting piece 45C is provided at a position that corresponds to the screw hole 31C formed in the unit housing portion 13 of the lower case 3. The hole 45a in the mounting piece 45D is formed at a position that corresponds to the screw hole 31D formed through the printed-wiring board 12. When the screw 32 is screwed into the screw holes 31A-31D through the respective holes 45a, the holding member 42 is fixed to the unit housing portion 13. It is to be noted that the battery 37 is arranged below the printed-wiring board 11.

Thus, the screwing position for attachment is common to the holding member 42 for the 2.5″ HDD 41 and the holding member 23 for the 1.8″ HDD 21. A mount provided on the unit housing portion 13 to attach thereto the 1.8″ HDD 21 or the 2.5″ HDD 41 whichever selected can be commonized, thus simplifying the configuration and facilitating assembly.

In such a manner, in the PC100, at least one unit selected from a group including a plurality of units such as the 1.8″ HDD 21, 2.5″ HDD 41, the printed-wiring board 22, etc. is installed into the unit housing portion 13 of the case 1 in the present embodiment. The 1.8″ HDD 21 and the 2.5″ HDD 41 have the same functions as a memory device unit and different occupied areas when arranged in a plane. The PC100 selects either one unit of the 2.5″ HDD 41 or the 1.8″ HDD 21 as a small-sized memory device unit having a smaller occupied area than the 2.5″ HDD 41 when arranged in a plane and installed it into the unit housing portion 13. When the 1.8″ HDD 21 is selected, it is possible to install the printed-wiring board 22, which is a unit that can be accommodated in a space that is made in the unit housing portion 13 when the 2.5″ HDD 41 is replaced by the 1.8″ HDD 21, for the wireless-LAN as a communication unit.

In such a manner, by selecting at least one desired unit from a group including a plurality of units having different sizes and functions and installing it into the unit housing portion 13, it is possible to supply a PC100 having a variety of specifications that can satisfy a user's desire. For example, it is possible to obtain such a PC as to have only the functions of the 2.5″ HDD 41 or such a PC as to combine the functions of the 1.8″ HDD 21 and those of the wireless LAN.

Furthermore, the attaching position of the holding member for fixing each unit to the unit housing portion 13 can be commonized for a plurality of units, thus utilizing the same case for such PCs as to have different specifications. The components can be commonized to thereby simplify the construction of the PC, thus reducing the manufacturing costs.

Therefore, this PC is capable of reasonably and economically installing a unit having a function required by a user into a case having the same size, thus satisfying a variety of specifications.

It is to be noted that electronic apparatus related to the present invention is not limited to a mobile PC described in the present embodiment but can be widely applied to general electronic apparatuses such as a Personal Digital Assistant (PDA).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An electronic apparatus comprising:
a case having a unit housing portion therein;
a printed-circuit board which is built into the case in a portion other than the unit housing portion; and
at least one unit which is selected from a group including a plurality of units having different occupied areas when arranged in a plane and is stored in the unit housing portion.

2. The electronic apparatus according to claim 1, wherein the selected unit may include a memory device unit.

3. An electronic apparatus comprising:
a unit housing portion provided inside a case and stored either one memory device unit or a unit set which includes a small-sized memory device unit having a smaller occupied area than the one memory device unit when arranged in a plane and at least one device unit which can be accommodated in a space which is made in the unit housing portion when the small-sized memory device unit is replaced by the one memory device unit.

4. The electronic apparatus according to claim 1, wherein:
said unit is fixed to the unit housing portion using a respective holding member which fits respective details; and
the holding members are screwed to an assembling portion provided on the unit housing portion common to the holding members.

5. The electronic apparatus according to claim 1, further comprising:
an auxiliary board which carries a unit selected from the group and connects the unit to the printed-wiring board.

6. The electronic apparatus according to claim 5, wherein said auxiliary board is detachably connected with the printed-wiring board.

7. The electronic apparatus according to claim 1, wherein the group includes at least two memory device units having different occupied areas when arranged in a plane.

8. The electronic apparatus according to claim 7, wherein the memory device unit includes a hard disk drive having a disk size of 2.5 inches and a hard disk drive having a disk size of 1.8 inches.

9. The electronic apparatus according to claim 7, wherein the group further includes a communication unit having a wireless communication function.

10. The electronic apparatus according to claim 1, wherein:
the group includes a hard disk drive having a disk size of 2.5 inches, a hard disk drive having a disk size of 1.8 inches, and a communication unit having a wireless communication function; and
the electronic apparatus further comprises:
a connector which is used commonly for the hard disk drives; and
a assembling portion which is common to a holding member which fixes the hard disk drive having a disk size of 2.5 inches when the hard disk drive having a disk size of 2.5 inches is selected from the group and stored in the unit housing portion, and a holding member which fixes the hard disk drive having a disk size of 1.8 inches and the communication unit when the hard disk drive having a disk size of 1.8 inches and the communication unit are selected from the group and stored in the unit housing portion.
